(19) United States
(12) Patent Application Publication
(10) Pub. No.: US 2008/0163224 A1
(43) Pub. Date: Jul. 3, 2008

(54) MODELING INTERRUPTS IN A BUSINESS PROCESS

(76) Inventors: Joachim H. Frank, Greenwich, CT (US); James E. Rumbaugh, Sarasota, CA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/618,182

(22) Filed: Dec. 29, 2006

(51) Int. Cl. G06F 9/46

(52) U.S. Cl. 718/102

(57) ABSTRACT

Embodiments of the present invention address deficiencies of the art in respect to process modeling of a process flow interruption and provide a novel and non-obvious method, system and computer program product for modeling interrupts in a business process. In one embodiment of the invention, a method for modeling interrupts in a business process can be provided. The method can include executing a task in a business process flow, detecting an interrupt that occurs while the task is executing, determining timing requirements for the interrupt, which may either call for an immediate response or for a response after the task has finished execution and launching an interrupt flow for the interrupt which may either displace, or complement, the task's regular output.

### BACKGROUND OF THE INVENTION

1. Field of the Invention

The present invention relates to the field of business process management and more particularly to managing interrupting events in a process flow for a business process.

2. Description of the Related Art

The business process program paradigm represents a revolutionary approach to wide-scale, distributed data processing. Business process programs utilize a loosely coupled integration model to allow flexible integration of heterogeneous systems in a variety of domains including business-to-consumer, business-to-business and enterprise application integration. Through the use of a messaging protocol, a common grammar for describing business process logic and an infrastructure for publishing and discovering services in a systematic way, business processes can “find” services, (whose implementation may be another business process) and can interact with them following a loosely coupled, platform-independent model.

Presently, the interaction model of the business process program can be viewed as a stateless model of synchronous or solicited asynchronous interactions. Models for business interactions typically assume sequences of peer-to-peer message exchanges, both synchronous and asynchronous, within stateful, long-running interactions involving two or more parties. Nevertheless, systems integration requires more than the mere ability to conduct simple interactions by using standard protocols. Rather, the full potential of the business process program paradigm as an integration platform can be achieved only when applications and business processes are able to integrate their complex interactions by using a standard process integration model that also includes support for unsolicited, spontaneous interactions (referred to as interrupts). Moreover, it must be possible to model the timing of handling interrupts in a running process (which may be immediate, or delayed) as well as its concurrency with the process flow in progress (which the interrupt may complement, or displace).

Workflow languages fulfill many if not all of the aspects of a standard process integration model. In this regard, typical workflow language specifications define a technology for integrating cross-enterprise business processes. By coordinating stateful interactions of loosely coupled services across enterprise boundaries, the workflow language can provide a means of modeling the interactions between an enterprise and its business partners, suppliers and customers and thus the value chain of the enterprise. Most importantly, a workflow language can define a notation for specifying business process behavior for use in a business process program.

Workflow languages differ from older, more traditional procedural programming languages in that workflow languages concentrate on allowing the applications developer to specify the interactions between existing processing logic in a business process program rather than requiring the developer to design a business process program and its accompanying processing logic from scratch. As a result, in the workflow paradigm, execution environments partition the program instructions into a number of disjoint tasks, often referred to as activities, which can be coupled together through a description of dependencies between the activities, often referred to as links.

Generally, an activity can include program logic which can be invoked by a process engine. For example, the program logic can be a locally or remotely invokable program object which can be activated by the process engine. The process engine can determine a sequence for invoking program logic based upon the links specified for different program objects. Consequently, a business process program can be conceptually viewed as a grouping of activities and links which are executed in run-time environment. Notably, unlike conventional procedural program logic, the processing logic or program objects of a business process program need not be invoked in the exact order specified by the developer. Rather, the process engine can remain free to execute program objects in any order so long as the constraints of the relationship links are satisfied.

Business processes are commonly modeled as directed graphs whose nodes represent steps or tasks and whose arcs represent either control or data dependency. The start of a task depends upon the completion of its dependencies. In a real-world process external to the computer model of a real-world business process, the process can be disrupted without warning in an unpredictable fashion. The effect of the disruption depends on the current state of execution of the process, which may involve one or more (concurrent) tasks. For each of the tasks that are executing when the interrupt occurs, the effect can be that its result is discarded (“displaced” by the interrupt) or used (interrupt is “additive’). In addition, any additional flow caused by the interrupt can be immediate, or deferred (awaiting task completion).

Some process modeling techniques permit modeling of an interruption to a process flow. Generally, in the few modeling techniques that permit the modeling of an interruption, upon receiving notification of an interruption, the currently executing task can terminate and become abandoned. Thereafter, a different task can commence rather than a task naturally following the terminated task in the flow. This is the case of an “immediate and displacing” interrupt. It will be recognized by the skilled artisan, then, that the few modeling techniques that permit modeling of an interruption remain inflexible in that they wholly ignore three other possibilities of handling an interrupt; “immediate and additive” (an interrupt flow occurs immediately, but the interrupted task still completes and its subsequent flow still occurs as it normally would); “deferred and displacing” (the interrupted task is allowed to complete, but the subsequent course of action is a different flow, which may use the task's result) and “deferred and additive” (the interrupted task is allowed to complete, but the subsequent course of action now has an additional flow, which may use the task's result.

### BRIEF SUMMARY OF THE INVENTION

Embodiments of the present invention address deficiencies of the art in respect to process modeling of a process flow interruption and provide a novel and non-obvious method, system and computer program product for modeling interrupts in a business process. In one embodiment of the invention, a method for modeling interrupts in a business process can be provided. The method can include executing a task in a business process flow, detecting an interrupt to the task, determining timing requirements for the interrupt, and either displacing, or complementing, the regular flow following task completion by the interrupt flow. Also, launching an interrupt flow for the interrupt can include loading a guard for the interrupt, evaluating the guard to determine whether or not to permit a launching of the interrupt flow, and launching the interrupt flow only if permitted by the guard.

In another embodiment of the invention, a business process data processing system can be provided. The system can include a business process engine configured for communicative coupling to a service directory of services hosted within remote hosts over a computer communications network. The system further can include interrupt handler logic. The logic can include program code enabled to detect an interrupt to an executing task for a business process flow managed by the business process engine, to determine timing requirements for the interrupt, to launch an interrupt flow immediately when specified by the timing requirements, and otherwise only after the task has completed, and to allow or disallow the flow that normally would have followed.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIGS. 1A through 1D, taken together, are a pictorial illustration of a business process model arranged for modeling interrupts in a business process;

FIG. 2 is a schematic illustration of a business process execution system configured for handling interrupts in a business process; and,

FIG. 3 is a flow chart illustrating a logic flow for handling interrupts in a business process execution system.

### DETAILED DESCRIPTION OF THE INVENTION

Embodiments of the present invention provide a method, system and computer program product for modeling interrupts in a business process. In accordance with an embodiment of the present invention, interrupts in a business process can be classified according to timing and concurrency. In particular, interrupts in a business process can be classified as either immediate or deferred, and as either additive or displacing. Responsive to detecting the receipt of an interrupt during the execution of a task in a business process flow, the classification for the interrupt can be inspected and acted upon accordingly. In this regard, interrupts of an immediate classification can result in the immediate launch of an interrupt flow. Conversely, interrupts of a deferred classification can permit the deferred launch of an interrupt flow. Also, interrupts of a displacing character can result in abandoning the “normal” flow of execution after an interrupted task in favor of the execution of an interrupt flow. In contrast, interrupts of an additive character can result in the concurrent execution of the interrupt flow along with the.

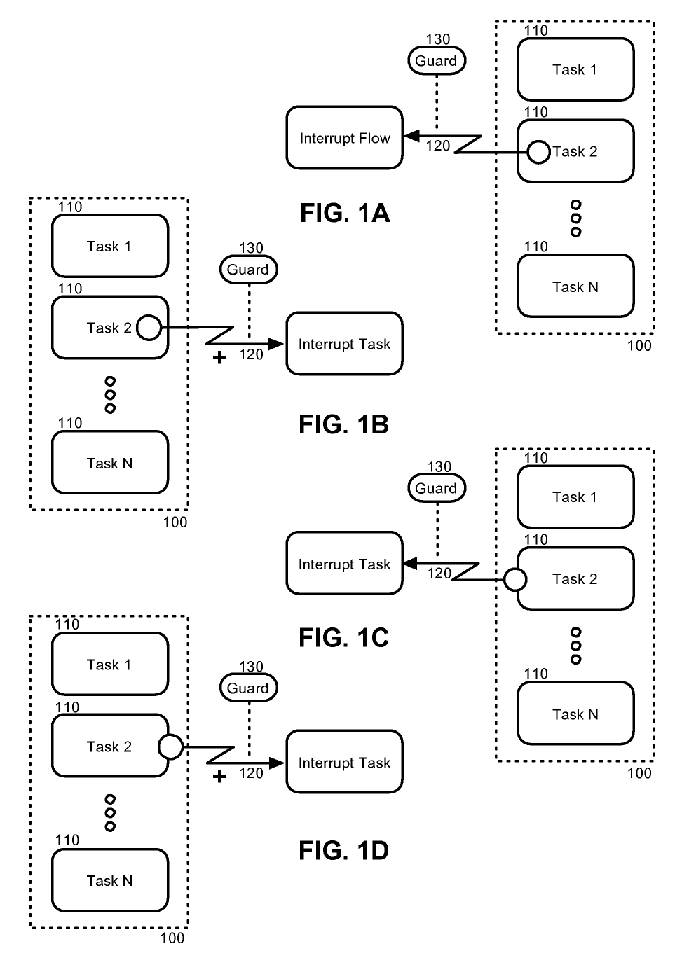

In further illustration, FIGS. 1A through 1D, taken together, are a pictorial illustration of a business process model arranged for modeling interrupts in a business process. As shown in FIGS. 1A through 1D, an interrupt can be modeled as a flow 120 leaving a node 110 in a business process flow 100. The interrupt can be “armed”, that is, sensitive to the occurrence of an interrupting event, as long as coupled node 110 or group of nodes is active. If an interrupting event occurs during that time, the interrupt has happened. The occurrence of the interrupt flow 120 then depends on the timing characteristic of the interrupt interrupt's timing property:

As shown in FIGS. 1A and 1B, for immediate interrupts, the interrupt flow 120 starts as soon as the interrupting event is processed. In contrast, as shown in Figures 1C and 1D, for deferred interrupts the interrupt flow 120 starts when the node 110 (or group of nodes 100) being interrupted has completed. It will be recognized, however, that an interrupt can be armed while process execution is within a “region” or group of nodes 100. In this particular circumstance, the hollow circle from which the interrupt flow 120 starts can be drawn at the interior of the dashed rectangle representing the group of nodes 100, and not at the interior of a particular node 110 within that group of nodes 100. Additionally, “deferred” interrupts can be forbidden on a region or group of nodes 100, since it can be difficult to determine when the region or group of nodes 100 has completed execution

A second characteristic of an interrupt flow 120 is its relationship to the regular outputs of an interrupted node (Task 2) 110 or group of nodes 100. As shown in FIGS. 1B and 1D, for additive interrupts the interrupt flow 120 occurs in addition to any regular output flows from the interrupted node (Task 2) 110. In contrast, for displacement interrupts shown in FIGS. 1A and 1C, the interrupt flow 120 occurs instead of the regular output flows of the interrupted node (Task 2) 110.

Optionally, in addition to the timing and concurrency properties of the interrupt flows 120 as described, interrupts can include guards 130. The guards 130 can include Boolean conditions that depend upon the state of the process flow. If present, the guards 130 can be evaluated at the time of the interrupt. In response, only if all guards 130 evaluate to true does the interrupt flow 120 occur. If any guard 130 is false, there is no effect from the interrupt on the node 110 or group of nodes 100 that specified the interrupt flow 120.

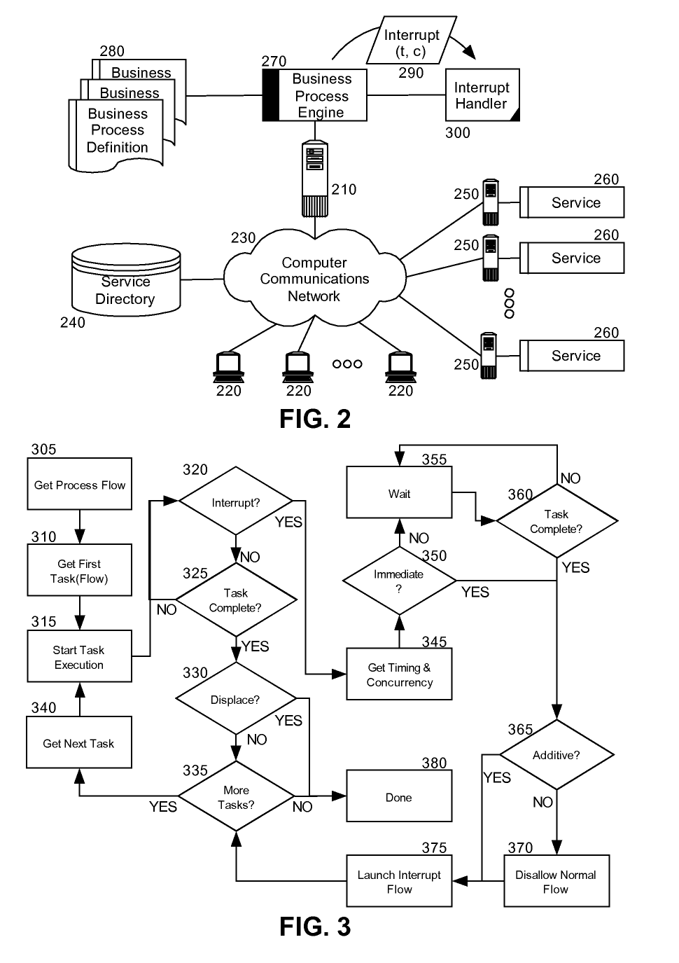

In yet further illustration, FIG. 2 is a schematic illustration of a business process modeling data processing system configured for modeling interrupts in a business process. The system can include a host computing platform 210 configured for communicative coupling to one or more computing clients 220 over computer communications network 230. The host computing platform 210 can support the operation of a business process engine 270 arranged to launch business process flows based upon one or more business process definitions 280. To launch the business process flows, the business process engine 270 can include a configuration for consulting service directory 240 to identify and retrieve service instances 260 hosted in remote hosts 250 over the computer communications network 230.

Notably, interrupt handler logic 300 can be coupled to the business process engine 270. The interrupt handler logic 300 can include program code enabled to process interrupt events 290 to launch interrupt flows either additively to an ongoing business process flow, or displacingly in place of an ongoing business process flow. The program code of the interrupt handler logic 300 further can be enabled to determine whether or not to immediately process the effects of an interrupt that is happening based upon properties of the interrupt 290.

Specifically, FIG. 3 is a flow chart illustrating a logic flow within a process execution engine that has been enabled for handling-interrupts in a business process modeling system. Beginning in block 305, a process flow can be retrieved for execution and in block 310, a first task in the process flow can be selected for execution. Thereafter, in block 315, the task execution can begin for the first task.

In decision block 320 it can be determined whether or not the process flow has been interrupted. If not, in decision block 325, it can be determined whether or not the task has completed. If not, the process can loop back to decision block 320. Otherwise, the process can continue through decision block 330. In decision block 330 it can be determined whether or not the process flow has previously been displaced by an interrupt. If so, the process can end in block 380. Otherwise, in decision block 335 it can be determined whether additional tasks remain to be processed in the process flow. If so, the next task in the process flow can be retrieved for execution and in block 315 the task can be executed. Thereafter, the process can repeat through decision block 325. When no further tasks remain to be executed in the flow, the process can end in block 380.

Returning to decision block 320, if it is determined that the process flow has been interrupted, in block 345, the timing and concurrency of the interrupt can be determined and in decision block 350, it can be determined whether the timing is immediate. If not, in block 355 the process can wait for the completion of the task. In this regard, in decision block 360 if it is determined that the task has completed, in decision block 365 it further can be determined whether the concurrency of the interrupt is additive or displacing. If it is determined that the concurrency is displacing, in block 370 the remaining process flow can be disallowed. In either case, in block 375 the interrupt flow can be launched. Thereafter, the process can continue through decision block 335 until no tasks remain to be retrieved in the process flow.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for handling interrupts in a business process, the method comprising:
executing a task in a business process flow;
detecting an interrupt to the task;
determining timing requirements for the interrupt; and,
processing the interrupt flow immediately when specified by the timing requirements, and otherwise after the task has completed.

2. The method of claim 1, further comprising:
determining concurrency requirements for the interrupt; and,
launching the interrupt flow in lieu of the business process flow when the concurrency requirements indicate displacement, and otherwise launching the interrupt flow in addition to the business process flow when the concurrency requirements indicate an additive property.

3. The method of claim 1, further comprising:
loading a guard for the interrupt;
evaluating the guard to determine whether or not to permit a launching of the interrupt flow; and,
launching the interrupt flow only if permitted by the guard.

4. A business process data processing system, the system comprising:
a business process engine; and,
interrupt handler logic comprising program code enabled to detect an interrupt to an executing task for a business process flow managed by the business process engine, to determine timing requirements for the interrupt, to launch an interrupt flow immediately when specified by the timing requirements, and otherwise after the interrupted task has completed.

5. The system of claim 4, wherein the interrupt comprises concurrency properties specifying whether to launch a corresponding interrupt flow in addition to the business process flow that would follow a normal completion of the interrupted task, or in place of the business process flow.

6. The system of claim 4, further comprising a guard coupled to the interrupt, the guard comprising a Boolean expression which when evaluated indicates whether or not to launch a corresponding interrupt flow.

7. A computer program product comprising a computer usable medium embodying computer usable program code for handling interrupts in a business process, the computer program product comprising:
computer usable program code for executing a task in a business process flow;
computer usable program code for detecting an interrupt to the task;
computer usable program code for determining timing requirements for the interrupt; and,
computer usable program code for launching an interrupt flow-immediately when specified by the timing requirements, and otherwise after the interrupted task has completed.

8. The computer program product of claim 7, wherein the computer usable program code for launching an interrupt flow for the interrupt, comprises:
computer usable program code for determining concurrency requirements for the interrupt; and,
computer usable program code for launching the interrupt flow in lieu of the business process flow that would have followed normal completion of the task when the concurrency requirements indicate displacement, and otherwise launching the interrupt flow in addition to the business process flow that would have followed normal completion of the task when the concurrency requirements indicate an additive property.

9. The computer program product of claim 7, wherein the computer usable program code for launching an interrupt flow for the interrupt, comprises:
computer usable program code for loading a guard for the interrupt;
computer usable program code for evaluating the guard to determine whether or not to permit a launching of the interrupt flow; and,
computer usable program code for launching the interrupt flow only if permitted by the guard.
